(19) United States
(12) Patent Application Publication
(10) Pub. No.: US 2007/0114780 A1
(43) Pub. Date: May 24, 2007

(54) Address book with update stickers

(76) Inventors: Amy Elizabeth Glosh, Kettering, OH (US); Jill Marie Broering, Troy, OH (US)

Correspondence Address: THOMPSON HINE L.L.P., P.O. BOX 8801, DAYTON, OH, 45401-8801, US

(21) Appl. No.: 11/286,605

(22) Filed: Nov. 23, 2005

(51) Int. Cl. B42D 1/00

(52) U.S. Cl. 281/15.1

(57) ABSTRACT

An address book including a plurality of bound pages, wherein each page has at least one address book entry printed thereon. The address book entry includes an information template including at least one of name, mailing address, phone number, e-mail address, anniversary date, passwords, frequent websites or birth date indicia arranged in a predetermined format. The address book further includes a plurality of update stickers coupled to the pages, each update sticker including an address book entry printed thereon. The address book entry printed on each update sticker includes the information template including at least one of name, mailing address, phone number, e-mail address, anniversary date, passwords, frequent websites or birth date indicia arranged in the predetermined format.

### BACKGROUND

The present invention relates to address books, and more particularly, to address books utilizing update stickers.

Information recorded in address books often becomes cluttered and of reduced usefulness over time. This is typically due to the repeated need to amend or remove entries, which often entails messy erasures, strike-overs, white-outs, etc. The most common reaction to this problem has been to simply replace the address books which requires a time consuming transfer of information from the old book to the new.

Accordingly, there is a need for an address book and updating system where the recorded information can be easily updated.

### SUMMARY

The present invention is an address book and updating system where the recorded information can be easily updated. In particular, in one embodiment the user can write the new information on an update sticker, remove the sticker from the associated sticker sheet, and adhere the updated sticker over the previously-written entry. The update stickers may have the same size, shape and indicia as the previously printed entries such that the written entries can be easily updated with a seamless look.

In one embodiment the invention is an address book including a plurality of bound pages, wherein each page has at least one address book entry printed thereon. The address book entry includes an information template including at least one of name, mailing address, phone number, e-mail address, anniversary date, passwords, frequent websites or birth date indicia arranged in a predetermined format. The address book further includes a plurality of update stickers coupled to the pages, each update sticker including an address book entry printed thereon. The address book entry printed on each update sticker includes the information template including at least one of name, mailing address, phone number, e-mail address, anniversary date, passwords, frequent websites or birth date indicia arranged in the predetermined format.

Other aspects of the invention will become apparent from the following description, the accompanying drawings and the appended claims.

### BRIEF DESCRIPTION OF THE DRAWINGS

FIG. 1 is a top view of one embodiment of the address book of the present invention, with the address book shown in its closed position;

FIG. 2 is a top view of the address book of FIG. 1, showing examples of completed information templates;

FIG. 3 is a top view of the address book of FIG. 1, showing a printed address book sticker page;

FIG. 4 is a top view of the address book of FIG. 3, showing a completed update sticker being removed from the sticker sheet; and

FIG. 5 is a top elevation view of the address book of FIG. 2, showing the update sticker of FIG. 4 adhered on the page of FIG. 2.

### DETAILED DESCRIPTION

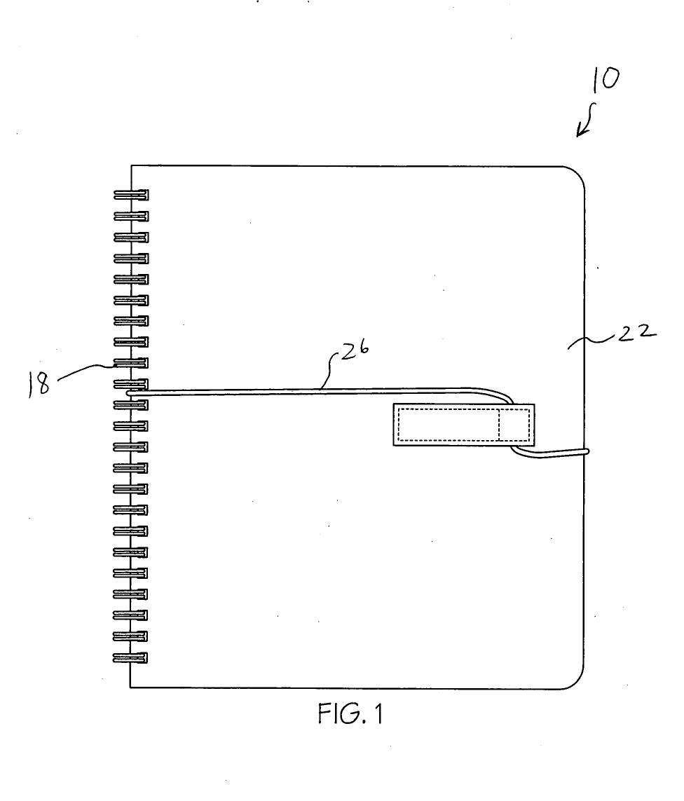

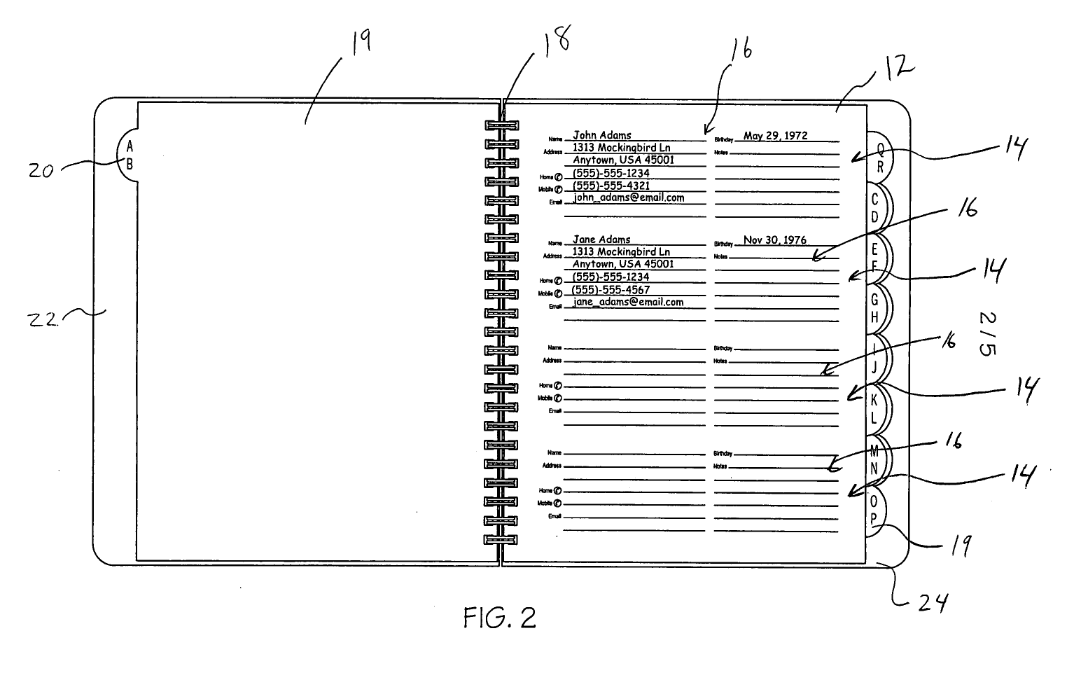

As shown in FIGS. 1-2, in one embodiment of the present invention, the address book 10 includes a plurality of bound pages 12. Each bound page 12 includes at least one address book entry 14 printed thereon. In the illustrated embodiment, each bound page 12 includes four address book entries 14 printed thereon, although the number of address book entries 14 can be varied as desired.

Each address book entry 14 may constitute or include an information template 16 which can include, for example, name indicia, mailing address indicia, phone number indicia, e-mail address indicia, anniversary date indicia, password indicia, frequent website indicia or birth date indicia arranged in a predetermined format. Each of the indicia can take the form of text, for example “Name” or “Telephone Number.” Alternately, the indicia can take the form of various other letters, symbols, abbreviations, drawings, etc. For example, a drawing or symbol of a telephone may constitute indicia used to represent a telephone number, and a drawing or symbol of a computer may constitute indicia used to represent an e-mail address.

In the illustrated embodiment, each template 16 includes a generally horizontally extending line located adjacent to each indicia to provide a space upon which a user can write appropriate information thereon. In the embodiment shown in FIG. 2, each address book entry/information template 14, 16 also includes a “Notes” section such that the user can record various additional pertinent information thereon. Each bound page 12 may be made of a generally water-absorbent material such as cellulose or pulp-based paper to allow a user to write information on the address book entries with a wide variety of writing instruments, including pen, pencil, marker and the like.

In the illustrated embodiment, the plurality of pages 12 are bound together by a binding mechanism 18. The binding mechanism 18 can take any of a variety of forms, including but not limited to coil binding mechanisms, spiral binding mechanisms, adhesive bindings, three-ring binders, prong binding mechanisms, case binding mechanisms, perfect binding mechanisms, stitched binding mechanisms, etc. A plurality of dividers 19 may be bound to the pages 12 to provide protruding alphabetical labels 20 which allow quick and easy indexing and accessing of the address information. Rather than having separate dividers 19, if desired, all or selected ones of the bound pages 12 could have alphabetical index tabs located thereon.

The address book 10 may include a front 22 and a rear 24 cover bound to the plurality of pages 12. Each cover 22, 24 can have a stiffness or thickness greater than the bound pages 12 to provide protection to the pages 12. For example, the covers 22, 24 can be made of cardboard, plastic, tweeds, faux leathers, cottons, silk and the like. The address book 10 may include a closure mechanism 26 to retain the book 10 in its closed position. For example, as shown in FIG. 1, in one embodiment the closure mechanism 26 takes the form of an elastic strap which can be expanded and passed around the front 22 and rear 24 covers to secure the book 10 in its closed position. However, the closure mechanism 26 can take any of a variety of forms including but not limited to extensible strap, non-extensible strap, hook and loop closure mechanisms, mechanical snaps, magnets, releasable adhesives, buttons, and ribbons. Furthermore, the closure mechanism 26 can be made of a solid material that is not stretchable. For example, rather than being made of an elastic material, the closure mechanism 26 may be made of paper, plastic, fabric, metal or the like.

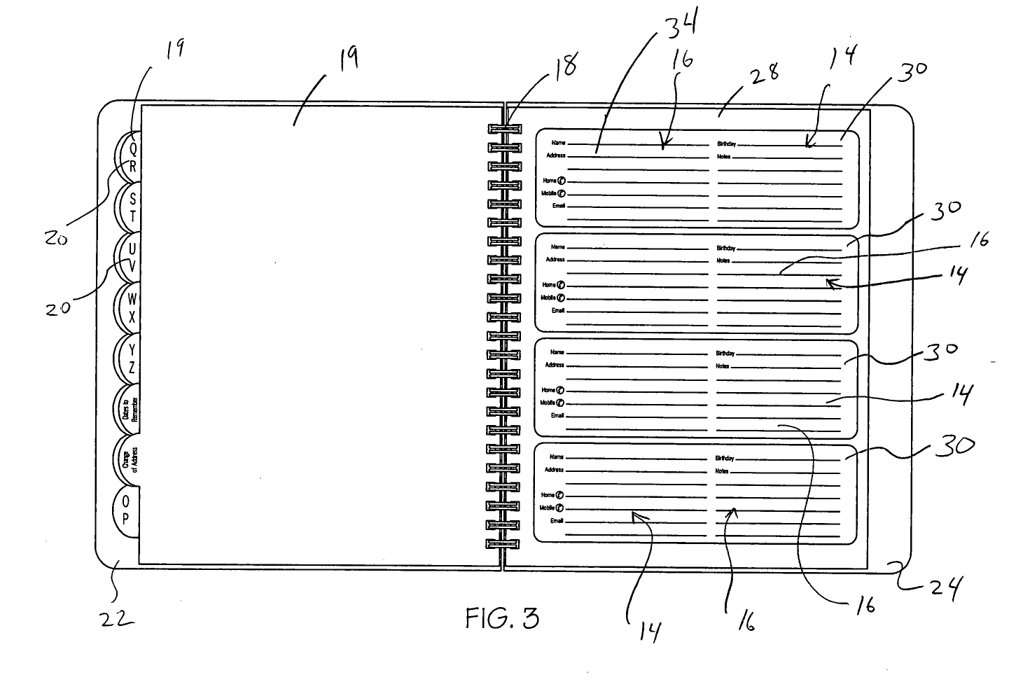

As shown in FIG. 3, the address book 10 may include a plurality of sticker sheets 28 bound to the pages 12 by the binding mechanism 18. In the illustrated embodiment, the sticker sheets 28 are located at the back of the address book and are located immediately below a divider 19 labeled “Change of Address.” However, the sticker sheets 28 can be located at any location throughout the thickness of the address book 10 and may be co-located with or without a divider 19, wherein the divider 19 may be configured with or without labeling. Each update sticker sheet 28 may have a size and shape generally corresponding to the size and shape of each of the bound pages 12.

Each sticker sheet 28 may include a plurality of update stickers 30 adhesively yet releasably located thereon. For example, in the embodiment shown in FIG. 3, the sticker sheet 28 includes four update stickers 30 located thereon, which correspond to the number of address book entries 14 on the bound pages 12. However, each sticker sheet 28 can include various numbers of update stickers 30 located thereon as desired.

Each update sticker 30 includes an address book entry 14 printed thereon. Each address book entry 14 may include the information template 16 arranged in the same format as the information template 16 located on each of the bound pages 12. In addition, each update sticker 30 may have a size and shape generally corresponding to the address book entry 14 of the bound pages.

Each sticker sheet 28 may be a two-ply sheet including a release liner 32 and an overlay sheet 34 with a pressure sensitive adhesive releasably adhering the overlay sheet to the release liner layer. The overlay sheet 34 may be die cut to define the plurality of update stickers 30 therein. The overlay sheet 34 (and thereby each update sticker 30) may be made of a generally water-absorbent paper material, such as cellulose or pulp-based paper. The release liner 32 maybe a non-porous, heat resistant substrate coated with a lubricant, such as wax or silicone oil to prevent the overlay sheet 34 from sticking when the update stickers 14 are desired to be removed. Representative examples of substrate include polyester, polypropylene, coated paper, and the like.

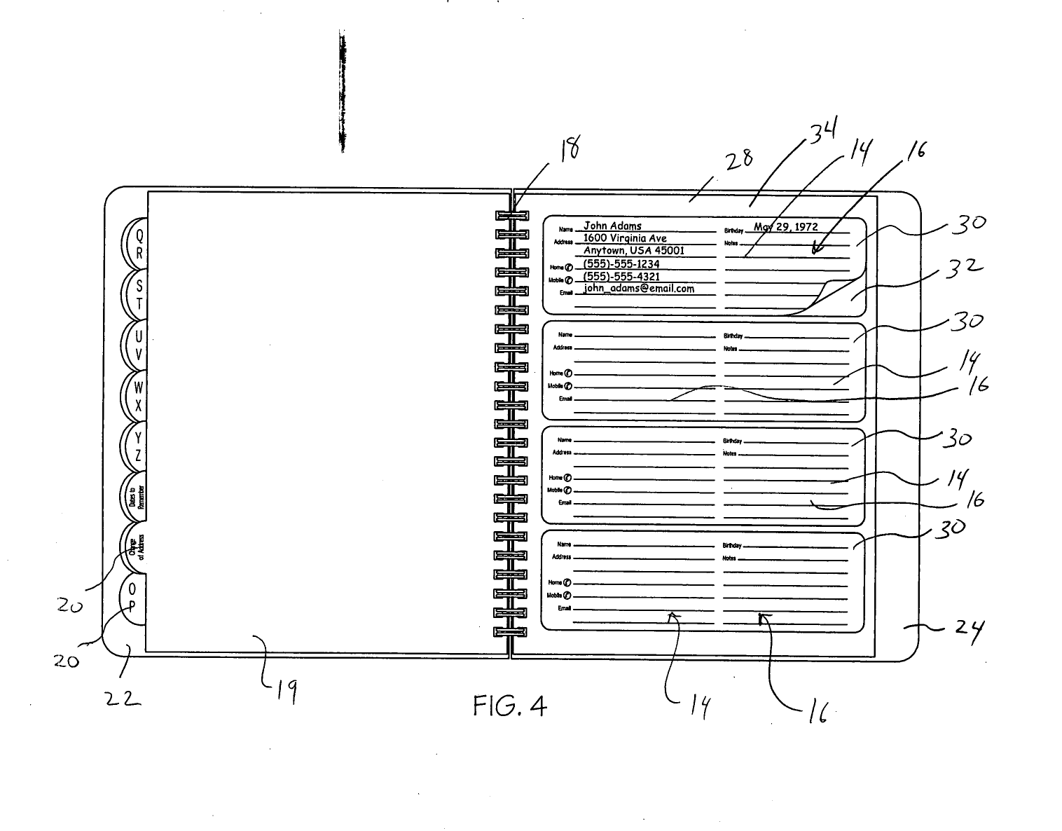

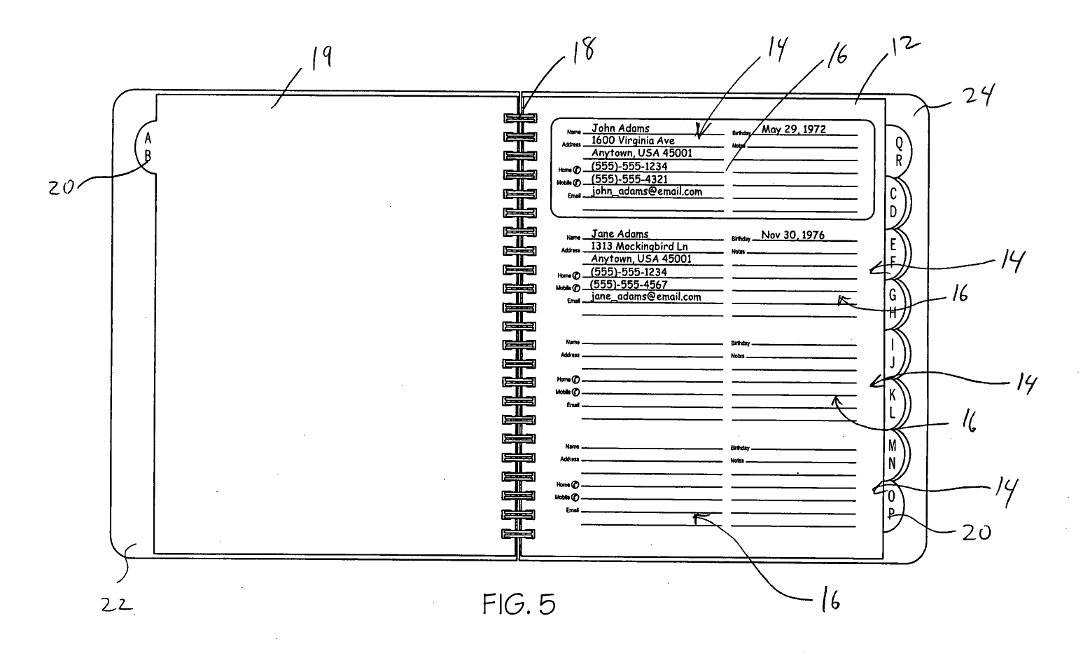

In order to utilize the address book 10, a user first writes the address information on the bound pages 12 in the standard manner. For example, as shown in FIG. 2, an entry for John Adams includes name, address, phone number, e-mail and birthday information manually printed thereon by a user. When the information for this entry needs to be updated (i.e., when the individual changes address), a user of the address book accesses the sticker sheets 28 as shown in FIG. 4. The new, updated (i.e., address) information for the individual is then printed onto one of the update stickers 30. The update sticker 30 is then peeled away from the release liner 32 located below, as shown in FIG. 4. The removed update sticker 30 is then adhered over the old printed information, as shown in FIG. 5.

Each update sticker 30 may be configured to be permanently adhered to the associated bound page 12. In particular, each update sticker 30/bound page 12 may be configured such that, once an update sticker 30 is adhered to a bound page 12, the update sticker 30 cannot be removed therefrom without at least partially tearing or removing part of the bound page 12 located below. However, it is within the scope of the present invention to provide update stickers/bound pages which do not become permanently adhered and which can be separated from each other without causing damage thereto.

As noted previously, each update sticker 30 may include an information template 16 in the same format as the information template 16 of each bound page 12. In this manner, when an update sticker 30 is adhered to a bound page 12 to provide updated information, as shown in FIG. 5, the format of the update sticker 30 matches the format of the remaining address book entries 16 on the printed sheet 12. In this manner, the use of the update stickers 30 provides a clean, seamless look, and allows the user to quickly and easily update information.

Although the invention is shown and described with respect to certain aspects, modifications may occur to those skilled in the art upon reading the specification. The address book with update stickers includes all such modifications and is limited only by the scope of the claims.

What is claimed is:

1. An address book, comprising:
a plurality of bound pages, wherein each page has at least one address book entry printed thereon, wherein said at least one address book entry includes an information template including at least two of name, mailing address, phone number, e-mail address, anniversary date, password, frequent websites or birth date indicia arranged in a predetermined format; and
a plurality of update stickers coupled to said pages, each update sticker including an address book entry printed thereon, said address book entry printed on each update sticker including said information template including at least two of name, mailing address, phone number, e-mail address, anniversary date, password, frequent websites or birth date indicia arranged in said predetermined format.

2. The address book of claim 1, wherein the address book entries on said pages and on said stickers are printed on a generally water-absorbent material.

3. The address book of claim 2, wherein the address book entries on said pages and on said stickers have generally the same size and shape.

4. The address book of claim 3, further comprising a front and a rear cover bound to said plurality of bound pages, wherein each cover has at least one of a thickness or stiffness greater than at least one of said pages.

5. The address book of claim 4, wherein each page has a predetermined number of address book entries printed thereon.

6. The address book of claim 1, wherein each page has a predetermined number of address book entries printed thereon, said address book further comprising at least one sticker sheet bound to said plurality of pages, said sticker sheet having exactly said predetermined number of update stickers releasably adhered thereto.

7. The address book of claim 6, wherein said sticker sheet has a size and shape generally corresponding to a size and shape of each of said plurality of pages.

8. The address book of claim 7, further comprising a plurality of sticker sheets bound to said plurality of pages.

9. The address book of claim 8, further comprising a binding mechanism binding said plurality of pages and said sticker sheets together.

10. The address book of claim 9, wherein said binding mechanism is a coil or spiral binding mechanism.

11. The address book of claim 10, wherein each sticker configured to be permanently adhered to one of the pages.

12. The address book of claim 11, wherein said pages are made of cellulose or wood pulp based paper.

13. The address book of claim 8, wherein each sticker sheet comprises
(i) a release liner layer;
(ii) an overlay sheet; and
(iii) pressure sensitive adhesive adhering said overlay sheet to said release liner layer,
wherein said overlay sheet is die cut to define a plurality of removable update stickers.

14. (canceled)

15. The address book of claim 1 wherein said information template includes name, mailing address, phone number, e-mail address, anniversary date, password, frequent websites or birth date indicia arranged in a predetermined format.

16. An address book, comprising:
a plurality of bound pages, wherein each page has at least one address book entry printed thereon, wherein said at least one address book entry includes an information template including at least one of name, mailing address, phone number, e-mail address, anniversary date, password, frequent websites or birth date indicia arranged in a predetermined format;
a plurality of sticker sheets bound to said pages, each sticker sheet having a plurality of update stickers releasably adhered thereto, each update sticker including an address book entry printed thereon, each address book entry including said information template, wherein the address book entries on said pages and said stickers each have generally the same size, shape and pre-printed information template, wherein each page has a predetermined number of address book entries printed thereon, and said sticker sheet has said predetermined number of update stickers carried thereon, wherein the address book entries on said pages and said stickers are made of a generally water-absorbent material; and
a front and a rear cover bound to said plurality of bound pages, wherein each cover has at least one of a thickness or stiffness greater than at least one of said pages.

17. An address book, comprising:
a plurality of bound pages, wherein each page has at least one address book entry printed thereon and arranged in a predetermined format, wherein each address book entry includes at least two information fields; and
a plurality of update stickers coupled to said pages, each update sticker including an address book entry including at least two information fields printed thereon and arranged in said predetermined format.

18. A method for using an address book comprising the steps of:
providing an address book including a plurality of bound pages, wherein each page has at least one address book entry printed thereon, wherein said at least one address book entry includes an information template including at least two of name, mailing address, phone number, e-mail address, anniversary date, passwords, frequent websites or birth date indicia arranged in a predetermined format, the address book further including a plurality of update stickers coupled to said pages, each update sticker including an address book entry printed thereon, each address book entry of each sticker including said information template including said at least two indicia;
manually writing original information onto an address entry of one of said bound pages;
manually writing new information onto an update sticker; and
adhering the update sticker with said new information to said one of said bound pages with said original information such that said update sticker covers the original information.

19. The address book of claim 6, wherein said sticker sheet has generally the same appearance as each of said bound pages.

20. The address book of claim 1, wherein said information template for said pages and each update sticker includes at least four of name, mailing address, phone number, e-mail address, anniversary date, password, frequent websites or birth date indicia arranged in a predetermined format.

21. The address book of claim 1 wherein said information template of each sticker is generally identical to said information template of said address book entry such that said address book entry of each page can be completely updated or replaced by a single one of said stickers.

22. The address book of claim 16, wherein said information template of said address book entry for said pages and each update sticker includes at least two of name, mailing address, phone number, e-mail address, anniversary date, password, frequent websites or birth date indicia arranged in a predetermined format.

23. The address book of claim 16, wherein said information template of said address book entry for said pages and each update sticker includes at least four of name, mailing address, phone number, e-mail address, anniversary date, password, frequent websites or birth date indicia arranged in a predetermined format.

24. The address book entry of claim 16, wherein said sticker sheet has exactly said predetermined number of update stickers carried thereon.

25. The address book of claim 16, wherein each sticker sheet has generally the same appearance as each of said bound pages.

26. The address book of claim 16 wherein said information template of each sticker is generally identical to said information template of said address book entry such that said address book entry of each page can be completely updated or replaced by a single one of said stickers.

27. The address book of claim 17, wherein each page has a predetermined number of address book entries printed thereon, wherein said address book further comprises at least one sticker sheet bound to said plurality of pages, said sticker sheet having exactly said predetermined number of update stickers releasably adhered thereto.

28. The address book of claim 17, wherein said address book further comprises at least one sticker sheet bound to said plurality of pages and carrying at least one of said plurality of stickers thereon, wherein said sticker sheet has generally the same appearance as each of said bound pages.

29. The address book of claim 17 wherein said address book entry of each sticker is generally identical to said address book entry of each page such that said address book entry of each page can be completely updated or replaced by a single one of said stickers.
